(19) United States
(12) Patent Application Publication
(10) Pub. No.: US 2021/0341992 A1
(43) Pub. Date: Nov. 4, 2021

(54) TOUCH RELATED DATA RECORDING DEVICE FOR EROTIC MEDIA AUGMENT

(71) Applicant: THIKA HOLDINGS LLC, St. Pete Beach, FL (US)

(72) Inventor: Vivien Cambridge, Myrtle Beach, SC (US)

(73) Assignee: THIKA HOLDINGS LLC, St. Pete Beach, FL (US)

(21) Appl. No.: 17/271,467

(22) PCT Filed: Aug. 23, 2019
(86) PCT No.: PCT/US2019/047870

§ 371 Date: Feb. 25, 2021

Related U.S. Application Data
(60) Provisional application No. 62/722,942, filed on Aug. 26, 2018.

(51) Int. Cl. G06F 3/01; A61H 19/00

(52) U.S. Cl. CPC G06F 3/011; A61H 19/44; A61H 2201/501; A61H 2201/013; A61H 2201/5061; A61H 2201/5071; A61H 2201/5097; A61H 2201/5043

(57) ABSTRACT

A video augmentation system is disclosed. The system includes a sensor configured to detect haptics signals associated with user manipulation; a camera configured to record images associated with the user manipulation; and a processor configured to combine the haptics signals and the images into a combined haptics/images file.

### CROSS REFERENCE TO RELATED APPLICATION

This application claims the benefit of U.S. Provisional Application No. 62/722,942, filed Aug. 26, 2018, which is incorporated by reference as if fully set forth.

### BACKGROUND OF THE INVENTION

Erotic interactive computer games, movies, videos, and erotic Internet interaction between partners using cameras, displays or other forms of “cams” such as “cam” websites and similar transmissions, have progressed in recent years to include connected devices that add a physical element to the activity. Particularly, users can use these devices and systems to watch movies, videos, or play games that are associated with a signal that causes a haptics output device to move in synchronization with actions portrayed in the movie. This output device is may be a device that imparts sensations to the user that mimics the sensations felt during erotic acts, such as the acts the user observes in the movies. Such haptics augmentation of media enhances the engaging and immersive qualities of the movie and thereby improves the experience of the user. The process of creating data that can be used with a movie to actuate accompanying haptics devices can be a labor-intensive, time-consuming and costly. Current systems for creating the data that accompanies a given video usually require human operators to manually enter data with a computer mouse or similar input device. This human data entry can result in imprecise synchronization. There are systems that use computer “vision” to detect motion in the video at hand and to create parameters that are related to this motion. These systems can function better than systems including human operators but they require favorable and well segmented depiction of objects that are tracked and they require that motion that is relevant to the video always being depicted clearly in the video. In the case of interactive erotic movies or videos, the haptics or other movement data may be related to acts performed with a phallic device. Actors engaging in such acts in the movie or video often manipulate the phallic device in such a way that the action simulates erotic acts with another human. For example, the actor may grasp and stroke the device in a way that is similar to the act of manually stimulating a human partner. Depending on the camera angles and directing of the video clip the actions of the actor may not always be in the field of view of the camera. In cases where the action is not clearly visible, computer-vision based techniques fail. In such cases, it would be advantageous if the data that is recorded is related directly to the actions of the actor. For this to take place, the phallic device should be designed to detect and transmits data related to the actions of the actor. Currently, such technology is relatively expensive, and the use of touch sensitive phallic devices also limits users to only phallic devices that are outfitted with touch sensing technology.

### SUMMARY OF THE INVENTION

In one embodiment, a system is provided that includes an inexpensive and easily implemented force detecting technology to generate data related to the manipulation of a phallic device which technology is incorporated in a system for automatically generating haptics augmented video.

The present embodiments include a system for automatically generating haptics data that augments a video that portrays a phallic device which is manipulated or otherwise used by an actor. The phallic device detects manipulation through measurement of forces that result from the manipulation. Specifically, the phallic device of the system detects the force that results along an axis, for example a longitudinal axis, when a user of the device grabs the device and strokes the device in a direction parallel to the longitudinal axis of the device. The force is detected through a force detecting transducer deployed at the base of the phallic device.

In an aspect of the invention, a force sensing pad has a smooth, flat surface suitable for receiving a suction cup dildo (or other similar device) and forces perpendicular to the pad surface result in pressure fluctuations within the pad which are detected and transmitted to a processor.

In an aspect of the invention, a video augmentation system is disclosed. The system includes a sensor configured to detect haptics signals associated with user manipulation; a camera configured to record images associated with the user manipulation; and a processor configured to combine the haptics signals and the images into a combined haptics/images file.

In another embodiment, a method of creating a combined haptics/images file is disclosed. The method includes detecting haptics signals associated with the user manipulation via a sensor; recording images associated with user manipulation via a camera; and combining the haptics signals and the images into a combined haptics/images file via a processor.

In an aspect of the invention, a video augmentation system is disclosed that includes a sex toy including a pressure transducer and bellows, the pressure transducer is connected to a conduit extending between the bellows and a pressure chamber, and the pressure transducer is arranged within the pressure chamber. A sensor is integrated within the sex toy, and the sensor is configured to detect haptics signals associated with user manipulation. A camera is configured to record images associated with the user manipulation. A processor is configured to combine the haptics signals and the images into a combined haptics/images file.

Additional embodiments, variations and aspects are disclosed herein.

### BRIEF DESCRIPTION OF THE DRAWINGS

The foregoing Summary and the following Detailed Description will be better understood when read in conjunction with the appended drawings, which illustrate a preferred embodiment of the invention. In the drawings:

FIG. 1 illustrates a first embodiment of a video augmentation system.

FIG. 2 illustrates a schematic of an embodiment of a video augmentation system.

FIG. 3 illustrates two different states of operation for a video augmentation system.

FIG. 4 illustrates a flow chart of a method for a video augmentation process.

FIG. 5 illustrates another embodiment of a video augmentation system.

FIG. 6 illustrates a flow chart of another method for a video augmentation process.

FIG. 7 illustrates an embodiment of a video augmentation system including an additional force detection component.

### DETAILED DESCRIPTION

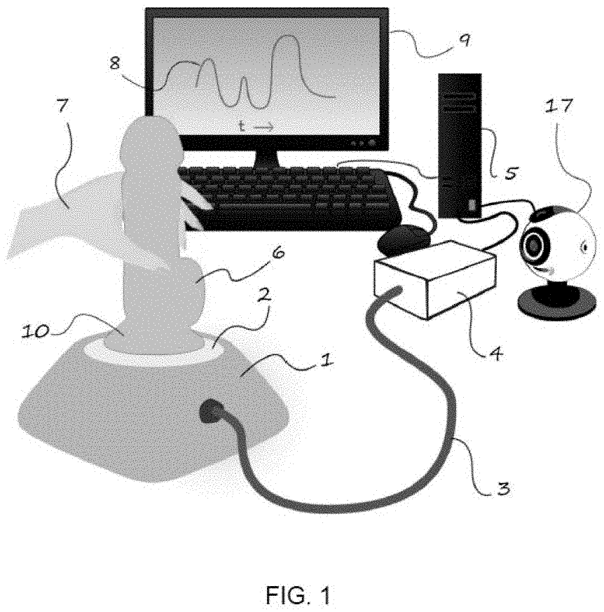

As shown in FIG. 1, a system of the first embodiment comprises a device housing 1 which encloses and supports a substrate plate 2. In an aspect of the invention, the substrate plate 2 is smooth and suitable for receiving suction cup 10. One of ordinary skill in the art would understand, based on the present disclosure, that the dimensions and shape of the substrate plate 2 can be modified. The suction cup 10 is part of a standard dildo device 6 suitable for attaching to smooth surfaces. One of ordinary skill in the art would understand that other attachment components than a suction cup can be used, and that dildos come in various shapes, sizes and varieties. A dildo can be referred to as a phallic device or object. Additionally, the dildo device 6 can lack a suction cup, and can be modified to add a suction cup or other attachment element. A user's hand 7 grasps the dildo device 6 and strokes the dildo device 6, for example along the longitudinal axis, to cause fluctuating force traverse to the substrate plate 2. The term dildo device 6 is used interchangeably herein with the term sex toy, toy, and/or input device.

Force on the substrate plate 2 is essentially transferred into the housing 1 and causes fluctuating pressure in a pneumatic hose 3, which is detected and transduced in a pressure transducer box 4. Although a pneumatic hose 3 is disclosed herein, other conduits can be used to transmit fluctuations in pressure, and various sensors can be used for detection as would be appreciated by a person of skill in the art. A resulting data signal from the pressure transducer box 4 is transmitted to a central processing unit (CPU) 5. The data signal is used in software in the CPU 5 to augment video recorded from a camera 17 which is oriented to record the manipulation of the dildo device 6 and transmits video data related to this manipulation to the CPU 5. Therefore, data that varies with manipulating strokes of the dildo device 6 can be visualized as, for example, in a signal-versus-time curve 8 and said data can be merged with video recorded through the camera 17 simultaneously with manipulation of the dildo device 6 so that this video is automatically and in real time augmented with haptics data. The signal-versus-time curve 8 can be mapped on a monitor or screen 9. The signal-versus-time curve 8 can be stored electronically via a memory unit.

The term video is used herein to refer to any record image, including full movies, clips, scenes, etc. The term haptics data is used herein to refer to any type of tactile, motion, touch, movement, and/or displacement data. The haptics data can include information representative of the magnitude, intensity, duration, and other characteristics of force applied to the dildo device 6. The haptics data is variable, such that the characteristics change instantaneously over time. The haptics data provides a realistic representative of a user manipulating the dildo device 6, and varies depending on the intensity, degree, and magnitude of a user's grip and force applied to the dildo device 6.

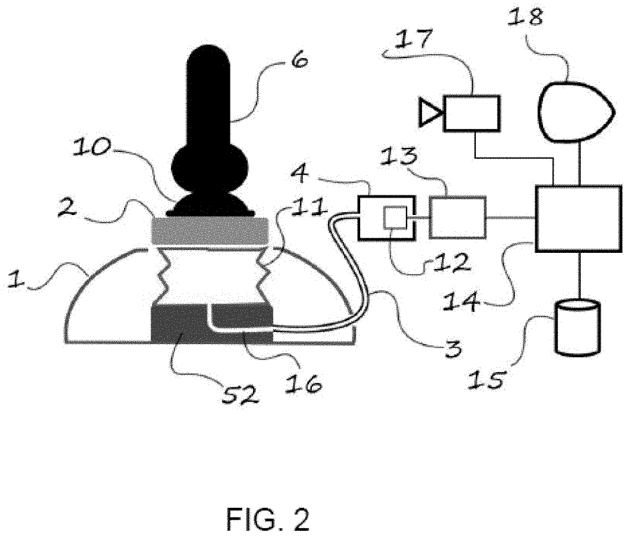

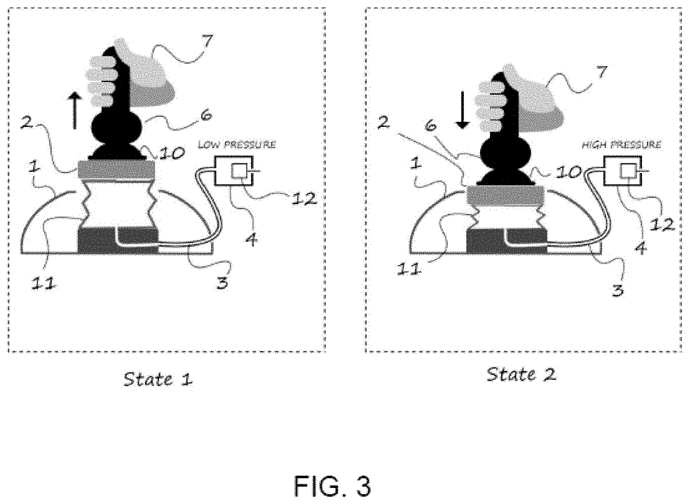

As shown in FIGS. 2 and 3, the dildo device 6 from FIG. 1 is again provided for manipulation by the user. FIG. 2 shows further details internal of the housing 1. As shown in FIG. 2, the smooth surface substrate 2 is attached to a bellows 11, which is contained in the housing 1. The bellows 11 is sealed or closed to the outside air except for an opening to pneumatic hose 3. In one embodiment, the term bellows generally refers to any component capable of compression, and which resiliently returns to an initial position after the compression. One of ordinary skill in the art would understand based on the present disclosure that other sealed chamber arrangements and/or extendable and compressible components could be used besides bellows. Any component capable of undergoing some type of displacement based on movement of the dildo device 6 can be used. In addition, other sensors or detectors could be used and positioned to detect movement and/or pressure, such as opto-electric sensors, mechanical sensors, pressure sensors, piezoelectric sensors, I/R sensors, break beam sensors, or the like as would be appreciated by a person of skill in the art.

As force and/or movement is exerted by a user on the dildo device 6 through, for example, stroking action or other movement (e.g, squeezing), this force is applied or transferred to the smooth substrate 2 which in turn causes compression or expansion of the bellows 11 or detection by another sensor. This expansion and contraction of the bellows 11, which is related to stroking action on the dildo device 6, causes pressure inside the bellows 11 to increase and decrease with stroking action of the dildo device 6.

FIG. 3 illustrates two different states of use for the system. As shown in State 1 in FIG. 3, when the user draws the dildo device 6 upward the bellows 11 expands and pressure in the pressure chamber 4 decreases. In State 2 of FIG. 3, the user pushes the dildo device 6 downward so that the bellows 11 is compressed and pressure in the pressure chamber 4 increases. As the pressure inside the bellows 11 increases, pressure through a conduit 16 in the base block 52 fluctuates accordingly and pressure fluctuations inside the bellows 11 are transmitted through the pneumatic hose 3 to the pressure chamber 4. Pressure fluctuations inside the pressure chamber 4 are sensed through the pressure sensor 12, and transduced in the processor 13 to generate pressure dependent signals which are transmitted to a central processing unit (CPU) 14. It is appreciated that other phallic device arrangements could be used, where a phallic object includes sensors for detecting movement and/or pressure, and transmit signals in response to the detection of movement and/or pressure, to a CPU.

The system furthermore includes a camera device 17 which records video of the manipulating action that causes a pressure dependent signal to be transmitted to the CPU 14, such that video of the manipulating action and said pressure dependent signal are related in time. Since the pressure dependent data is related to the manipulating action of the user on the dildo 6, this pressure dependent data may be used as haptics data in other devices that impart haptics sensations to viewers of the recorded video. The system includes software which combines pressure dependent data and video to create video data that is augmented with haptics data within a single combined data file. The system includes a monitor 18 for viewing or displaying video, and data is stored in a memory storage unit 15. The term monitor is used herein to include any display or screen, such as a computer monitor, television, smart phone screen.

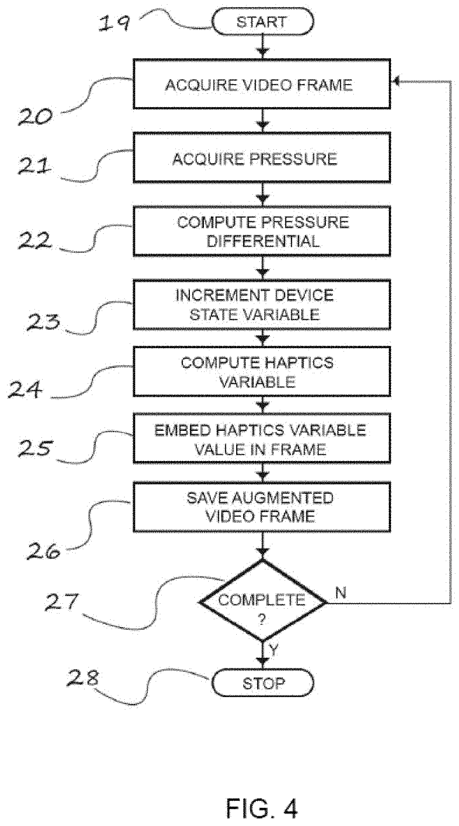

After start step 19, the logic flow of the first embodiment as shown in FIG. 4 commences in step 20 by acquiring a frame from video stream captured by the camera 17 and step 21 of acquiring contemporaneous pressure dependent data point from the pressure transducer 12. The acquired pressure dependent data is then used in step 22 to compute a differential variable indicating a time differential change in the state of the system. At step 23, this differential is incremented to generate a device state variable, which is used in step 24 to compute a stroke dependent variable which is used to augment video with haptics data during step 25. The haptics augmented video frame is saved during step 26, and this system continues until the process is complete at step 27. A loop is performed of steps 20-27 until an entire file is created that combines multiple video frames with multiple data points of haptics data. The flow chart finishes at the stopping step 28.

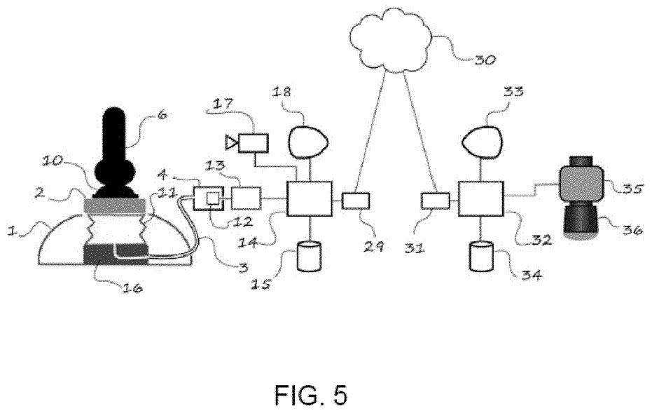

FIG. 5 illustrates another embodiment of a video augmentation system. The embodiment of FIG. 5 is similar to the embodiment of FIGS. 1 and 2 except for explicit distinctions identified below. As described with respect to the other embodiments, pressure fluctuations inside the pressure chamber are sensed through the pressure sensor 12 and transduced in the processor 13 to generate pressure dependent signals which are transmitted to the CPU 14.

Since the pressure dependent data is related to the manipulating action of the user on the dildo, this pressure dependent data may be used as haptics data in devices that impart haptics sensations to viewers of the recorded video. The system includes software which combines pressure dependent data and video to create video data that is augmented with haptics data.

The system of another embodiment further includes a communication system in which data from one user can be transmitted and received by another user. The communication system can be accomplished via any known communication protocols, including the Internet, networking devices, WiFi, etc. As shown in FIG. 5, transmission means 29 transmit haptics augmented video frames in real time through a network connection, schematically illustrated as cloud 30, to a remote receiving means 31. The remote receiving means 31 transfers haptics augmented video frames to a remote CPU 32 which includes a remote storage means 34 for storing haptics augmented video and remote display means 33 for displaying video. The term CPU is used herein to refer to any computing unit, such as a personal computer, laptop, smartphone, or other electronic device.

The remote CPU 32 includes software for extracting haptics data from a haptics video stream. The system furthermore includes haptics output device 35 which actuates a pleasure device 36 which imparts physical sensations on a user who is viewing video stream on a remote display 33, and the physical sensations are based on haptics data received from transmission means 29 and extracted by software in the CPU 32. The term pleasure device 36 is used broadly and generally to include any user device configured to provide some impulse or output. One of ordinary skill in the art would understand that the haptics output device 35 and the pleasure device 36 can include any number of devices. In an aspect of the invention, the pleasure device 36 is an elastomeric sleeve including actuators that are configured to output impulses based on the data from the processor 13. In real-time, as a first user strokes the device 6, then a second user (at a remote location) experiences the exact same stroking motion via the pleasure device 36. In an aspect of the invention, the first user can be a webcam performer. One of ordinary skill in the art would understand that this system can be adapted and adjusted in a variety of ways. For example, in an aspect of the invention, multiple users can have access to pleasure devices that are in communication with the processor 13. Accordingly, a single user can manipulate the device 6, while multiple users experience the stroking motion output on individual pleasure devices 36. One of ordinary skill in the art would understand that communication via voice or video can be provided between the users of the system.

Based on the present disclosure, one of ordinary skill in the art would understand that the pleasure device 36 can provide a physical output in variety of ways, including mechanical impulses, movement, grip-like pressure variations, torque, etc. Additionally, the pleasure device 36 can provide or may comprise lubrication, heat, and other features to the user.

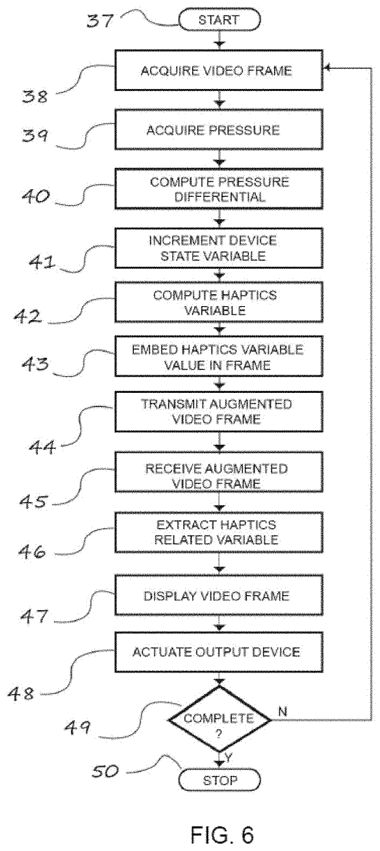

Starting at step 37, the logic flow of a second embodiment as shown in FIG. 6 commences with step 38 including acquiring a frame from video stream captured by the camera 17, and step 39 of acquiring contemporaneous pressure dependent data point from the pressure transducer 12. At step 40, pressure dependent data acquired is used to compute differential variable indicating time differential changes in the state of the system. At step 41, this differential is integrated to generate a device state variable which is used to compute a stroke dependent variable at step 42, which is used to augment video with haptics data at step 43. At step 44, the haptics augmented video frame is transmitted to a remote processor which receives augmented video frame at step 45, and extracts haptics related variable at step 46. In step 47, the remote processor displays the video frame and actuates remote haptics output device at step 48. This process is carried out in a loop until completion at step 49. Finally, the process can be stopped at step 50.

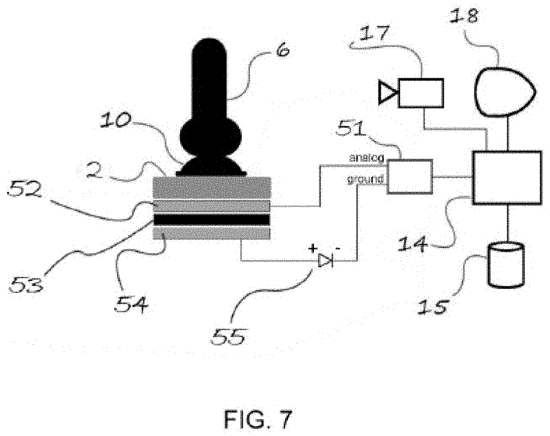

In another embodiment, shown in FIG. 7, the substrate plate 2 experiences fluctuating (movement) force via a user exerting force on the device 6, such that a conductive sheet 52 also experiences the fluctuating force. The term conductive sheet is used herein to refer to any sheet or film that is capable of conducting a signal, i.e. an electrical signal or physical signal. The fluctuating force alters a dimension, such as the thickness, of a piezoresistive material 53. As a user grips the device 6 and moves the device 6 up and down, the piezoresistive material 53 is essentially repeatedly squeezed between the conductive sheet 52 and another second conductive sheet 54. Resistance in a circuit, which includes the conductive sheet 52 and the piezoresistive material 53, is altered based on the fluctuating forces. In an aspect of the invention, the second conductive sheet 54 is provided to connect the conductive sheet 52 and the piezoresistive material 53 to a diode 55. The diode 55 is connected to a processor 51. Based on this arrangement, a varying resistance of the circuit is measured and recorded in the processor 51. Although a piezoresistive material is described in this embodiment, one of ordinary skill in the art would understand that other elements can be used that are configured to produce a signal, such as an electrical signal including voltage or resistance, based on application of an impulse, such as a physical impulse or force. The piezoresistive material 53 provides the same function as the bellows arrangement described herein, but automatically provides a digital signal based on the fluctuations from a user. FIG. 7 also illustrates a CPU 14, memory unit 15, camera 17, and monitor 18.

Signals in the processor 51 are transmitted to a central processing unit 5, and are processed and used in the same way as described herein with respect to the other embodiments. The data signal is used in software in a CPU 5 to augment video recorded from a camera 17, which is oriented to record the manipulation of the dildo device 6, and transmits video data related to this manipulation to the CPU 5. Therefore, data that varies with manipulating strokes of the dildo device 6 can be visualized as, for example, in a signal-versus-time curve 8 and said data can be merged with video recorded through the camera 17 simultaneously with manipulation of the dildo device 6 so that the video is automatically augmented in real-time with haptics data.

One of ordinary skill in the art would understand that the conductive sheet or film from the embodiment of FIG. 7 can be integrated into any one or more of the other embodiments described herein.

A system is disclosed herein in which stroking actions performed on a phallic device are detected through force fluctuations at the base of the dildo device and where electronic signals related to these forces are used to augment video that captures those actions. Electronic signals related to forces that result from stroking actions on the phallic device are transmitted to a remote processor and are used to actuate a haptics output device located at the remote processor.

Other embodiments are provided that economically and effectively implement the system of the present disclosure. For example, forces at the base of the phallic device may be detected through force sensing means that include load cell sensors or analog force-sensing means.

Having thus described the present embodiments in detail, it is to be appreciated and will be apparent to those skilled in the art that many physical changes, only a few of which are exemplified in the detailed description of the embodiments, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

1.-9. (canceled)

10. A method of creating a combined haptics and image file, the method comprising:
detecting haptics signals associated with manipulation of an input device by a user via a sensor;
recording images associated with the manipulation of the input device by the user via a camera; and
combining the haptics signals and the images into a combined haptics and image file via a processor.

11. The method of claim 10, wherein the haptics signals are generated in response to pressure-dependent data associated with a pressure transducer.

12. The method of claim 10, further comprising simultaneously driving an output device based on the haptics signals from the combined haptics and image file and displaying a video based on the images from the combined haptics and image file.

13. The method of claim 12, wherein the output device is a sex toy.

14. (canceled)

15. The method of claim 13, wherein the sex toy is mounted on a base block, and further includes at least one of:
(i) bellows arranged inside the base block, and a conduit connects the base block to a pressure chamber including a pressure transducer, or (ii) a piezoresistive material integrated inside the base block.

16. The method of claim 15, further comprising acquiring contemporaneous pressure-dependent data from the pressure transducer.

17. The method of claim 16, further comprising acquiring a plurality of frames from a video stream captured by the camera, and further comprising using the acquired plurality of frames and the pressure-dependent data to generate a time differential variable associated with the manipulation of the input device by the user.

18. The method of claim 10, further comprising transmitting the combined haptics and image file via a network to a remote receiver, and the remote receiver is connected to an output device.

19. A video augmentation system comprising:
a mounting block configured to attach to a sex toy, the mounting block including an integrated sensor adapted to provide haptics signals in response to movement associated with the sensor due to user manipulation of the sex toy;
a camera configured to record images associated with the user manipulation of the sex toy; and
a processor configured to combine the haptics signals and the images into a combined haptics and image file.

20. The system of claim 19, further comprising:
an output device, wherein the output device is configured to move in response to the haptics signals from the combined haptics and image file; and
a display unit, wherein images are displayed on the display unit and the output device is simultaneously driven based on the combined haptics and image file.

21. A device for detecting manipulation of a sex toy, the device comprising:
a housing including a base and a receiving surface;
a substrate plate supported on the receiving surface of the housing, the substrate plate including a surface configured for engagement with a sex toy; and
a sensor integrated within the substrate plate, the sensor being configured to detect force fluctuations of the substrate plate associated with manipulation of the sex toy and further configured to generate a signal associated with the detected force fluctuations.

22. The device of claim 21, wherein the sensor comprises a piezoresistive sensor.

23. The device of claim 22, wherein the device further comprising a processor in electrical communication with the sensor, and the processor is configured to transmit the signal from the sensor to a remote location.

24. The device of claim 22, wherein the piezoresistive sensor comprises:
a first conductive sheet positioned below the substrate plate,
a piezoresistive material sheet arranged below the first conductive sheet, and
a second conductive sheet arranged below the piezoresistive material sheet.

25. The device of claim 24, wherein the piezoresistive material sheet is compressed between the first conductive sheet and the second conductive sheet during manipulation of the sex toy.

26. The device of claim 21, further comprising a camera configured to record images associated with the manipulation of the sex toy.

27. The device of claim 26, further comprising a processor configured to combine the recorded images from the camera with the signal from the sensor.

28. The device of claim 21, further comprising a pressure transducer connected to the housing.

29. The device of claim 28, wherein the pressure transducer includes bellows,
the pressure transducer is connected to a conduit extending between the bellows and a pressure chamber, and
the pressure transducer is arranged within the pressure chamber.

30. The device of claim 21, wherein an output device is configured to be moved or driven based on the manipulation of the sex toy.
